(19) United States
(12) Patent Application Publication
(10) Pub. No.: US 2019/0211859 A1
(43) Pub. Date: Jul. 11, 2019

(54) FURNITURE CONNECTING PIECE

(71) Applicants: Jie Liu, Dongguan (CN); Lei Cao, Dongguan (CN)

(72) Inventors: Jie Liu, Dongguan (CN); Minsheng Liu, Dongguan (CN)

(21) Appl. No.: 15/862,649

(22) Filed: Jan. 5, 2018

(51) Int. Cl. F16B 12/12; F16B 19/10; F16B 12/14; F16B 12/24; F16B 12/26

(52) U.S. Cl. CPC F16B 12/125; F16B 19/1081; F16B 12/26; F16B 12/24; F16B 12/14

(57) ABSTRACT

The present invention relates to a connecting piece, and more particularly to a furniture connecting piece for connecting a pair of furniture plates. The furniture connecting piece includes a base, at least one tenon and at least two columns; the tenon is arranged on the top of the base, the columns are arranged at the bottom of the tenon. The furniture connecting piece can be used alone to join two plates or used with the other furniture connecting piece in pairs to connect a pair of furniture plates. It can be easily assembled and disassembled, it is worth of promotion and use.

### FIELD OF THE INVENTION

The present invention relates to a connecting piece, and more particularly to a furniture connecting piece for connecting a pair of furniture plates.

### BACKGROUND OF THE INVENTION

There are many ways in which structure such as furniture, cabinets, wardrobe, office casual tables and office furniture are fitted together. Such arrangements include fasteners such as nuts and bolts, wooden dowels, nails and other types of intricate locking mechanism. The shortcomings of these arrangements are that the products are totally fixedly connected, which is not easily operated for user. Only the user who commands some assembling and operating skills can assembly well and the assembling furniture is not easily disassemble. If the product is assembled at workplace, the dimension of the package of the product will very large, which will not convenient for transportation and increase the transportation cost.

Modular and customizable furniture pieces, such as desks and other work surfaces, are commercially desirable for certain applications and often utilize connecting pieces which facilitate easy assembly and disassembly.

In U.S. Pat. No. 8,784,029 discloses an insertion type furniture connecting piece that includes a female buckle, a middle buckle and a sub-buckle. The female buckle is a hollow cylinder whose inner wall is formed with a positioning ring. The middle buckle is a hollow rod having an insertion hole in its axis direction, the rod wall of the front end portion of the middle buckle is provided with axis direction slits, and the exterior rim of the front end portion of the middle buckle engages with the inner wall of the female buckle having the positioning ring. The sub-buckle is a rod-shaped body which can be inserted into the insertion hole and which has a diameter matching with that of the insertion hole. Furniture panel can be connected by inserting the middle buckle into the female buckle and inserting the sub-buckle into the middle buckle without using a tool, facilitating the assembly of the furniture. The connection of the connector is stable due to the positioning of the middle buckle by the positioning ring. In this patent, the middle buckle and the sub-buckle must go thought the mounting hole in one furniture panel and insert into the female buckle installed in the other furniture panel. However for thicker furniture panels, it is not very suitable to drill a hole, and without the hole, the middle buckle and the sub-buckle can not go through the thicker furniture panels. Thus, the insertion type furniture connecting piece can not used to connect thicker furniture panels.

In U.S. Pat. No. 8,641,315 B2 discloses a male connecting piece and a female connecting piece. The male connecting piece includes a male base with one or several protruding posts arranged on it, the female connecting piece includes a female base with one or several recesses arranged on the top surface of it; the protruding posts is engaging with the recesses respectively respectively. However, it needs a male connecting piece and a female connecting piece to connect two boards.

### SUMMARY FOR THE INVENTION

The present invention relates to a furniture connecting piece for connecting a pair of furniture plates or the similar articles together.

In accordance with one object of the present invention, the furniture connecting piece includes a base, at least one tenon and at least two columns; the tenon is arranged on the top of the base, the columns are arranged at the bottom of the tenon.

The tenon is designed as elliptic cylinder with big top and small bottom, the upper of the tenon is elliptic cylindrical, the lower part of the tenon is removed apart from both sides of the elliptic cylinder to form triangular cross section.

The column is provided with chamfered teeth around its body. With the chamfered teeth the furniture connecting piece can firmly bite the wall of the furniture plate.

When the furniture connecting piece is inserted into the mounting hole in the furniture plate with its columns, the columns will extrude the wall of the mounting hole, the furniture plate will suffer pressure. If the furniture plate is thinner or the expanding properties of the furniture plate are worse, the furniture plate is easy to burst or damage. Preferably, the front and rear sides of the column along its length direction are set as planes, thus the area of the chamfered teeth will be reduced, the pressure on the furniture plate will be reduced, thereby avoiding the furniture plate to burst or damage.

Preferably, some glue holes are arranged on the planes on the column for holding some glue to provide firmly connection.

Preferably, a terrace is arranged between the base and the columns. The diameter of the terrace is bigger than the that of the column. Generally, before the column is inserted into the mounting hole in the furniture plate, some glue will be filled in the mounting hole and coated around the column. It depends on the frictional force between the column and the wall of the mounting hole and the adhesive force of the glue to fix the furniture connecting piece and the furniture plate. When the column is inserted into the mounting hole, the glue will spill over the mounting hole. The terrace can block the mounting hole and prevent the spillover of the glue, therefore increasing connection strength. And the diameter of the terrace is bigger, also increases the connection area between the columns and the tenon therefor increasing the connection strength of them.

Preferably, the top surface of the terrace is a plane. When the furniture connecting piece is inserted into the mounting hole in the furniture plate, the top surface of the terrace can be set at the same level with the furniture plate, while the bottom face of the tenon between two of the terrace must be above the furniture plate. Therefore, the bottom face of the tenon between two of the terrace can not be at the same level with the top surface of the terrace. There must be a little space between them. The bottom face of the tenon between two of the terrace is higher than the top surface of the terrace.

Preferably, the tenon is provided with some sawteeth, when the tenon is inserted into the mounting hole in the plate, the sawteeth bite the wall of the mounting hole, It will not loosen even used for a long time.

In accordance with the other object of the present invention, a pair of furniture connecting pieces includes a furniture connecting piece and a female furniture connecting piece; the furniture connecting piece includes a base, at least one tenon is arranged on the top of the base, at least two columns are arranged at the bottom of the tenon; the female furniture piece includes a base with a mortise matching with the tenon and used for holding and locking the tenon. As will be appreciate, when the two furniture plates need to be connected, the furniture connecting piece and the female furniture connecting piece are pre-embedded into the surface of them respectively, and then the tenon is inserted into the mortise thereby achieving a seamless connection between the two furniture plates. Thus the users can assemble and disassemble the furniture components without a tool.

It should be understood the tenon and the mortise are matched with each other in shape and size. However, the present invention is not limited the shape and the size of them. Theoretically, the shape and the size can be changed at will without divorcing from the basic idea of the invention. For example, the tenon can be designed as funnel-shaped cross section, inverted pear cross section, cylindrical shape, rectangular shape, etc.

Preferably, the tenon is provided with some saw-teeth, accordingly the mortise is provided with some occlusal teeth. Thus the connection between tenon and the mortise is firmed. It will not loosen even used for a long time.

The advantageous effects of the invention are as follows: The furniture connecting piece can be used alone to join two plates or used with the other furniture connecting piece in pairs to connect a pair of furniture plates. It can be easily assemble and disassemble. It is worth of promotion and use.

### DESCRIPTION OF THE DRAWINGS

FIG. 1 is a perspective view of the furniture connecting piece in accordance with a first embodiment of the invention.

FIG. 2 is a front view of the furniture connecting piece shown in FIG. 1.

FIG. 3 is a side view of the furniture connecting piece shown in FIG. 1.

FIG. 4 is a top view of the furniture connecting piece shown in FIG. 1.

FIG. 5 is an assembly view of the furniture connecting piece shown in FIG. 1. The view shows that the furniture connecting piece is installed in a furniture plate with its columns.

FIG. 6 is a perspective view of the furniture connecting piece in accordance with a second embodiment of the invention.

FIG. 7 is a perspective view of the furniture connecting piece in accordance with a third embodiment of the invention.

FIG. 8 is a perspective view of the furniture connecting piece in accordance with a fourth embodiment of the invention.

FIG. 9 is a perspective view of the furniture connecting piece in accordance with a fifth embodiment of the invention.

FIG. 10 is a perspective view of the furniture connecting piece in accordance with a sixth embodiment of the invention.

FIG. 11 is a perspective view of the furniture connecting piece in accordance with a seventh embodiment of the invention.

FIG. 12 is a perspective view of the furniture connecting piece in accordance with a eighth embodiment of the invention.

FIG. 13 is a perspective view of the furniture connecting piece in accordance with a ninth embodiment of the invention. The view shows that the furniture connecting piece is used to join two plates.

FIG. 14 is a perspective view of the furniture connecting piece in accordance with the invention.

FIG. 15 is a perspective view of the pairs of the furniture connecting piece and the furniture connecting piece in accordance with a first embodiment of the invention. The view show that the pairs of the furniture connecting piece and the furniture connecting piece is used in pairs to join the two plate.

FIG. 16 is a perspective view of the pairs of the furniture connecting piece and the furniture connecting piece in accordance with a second embodiment of the invention. The view show that the pairs of the furniture connecting piece and the furniture connecting piece is used in pairs to join the two plates.

FIG. 17 is a perspective view of the pairs of the furniture connecting piece and the furniture connecting piece in accordance with a third embodiment of the invention. The view show that the pairs of the furniture connecting piece and the furniture connecting piece is used in pairs to join the two plates.

### DETAILED DESCRIPTION OF ILLUSTRATION EMBODIMENTS

In order to concretely illustrate the technical solutions and structure features of the furniture connecting piece of the present invention, the follow will further illustrate with specific embodiments and the drawings.

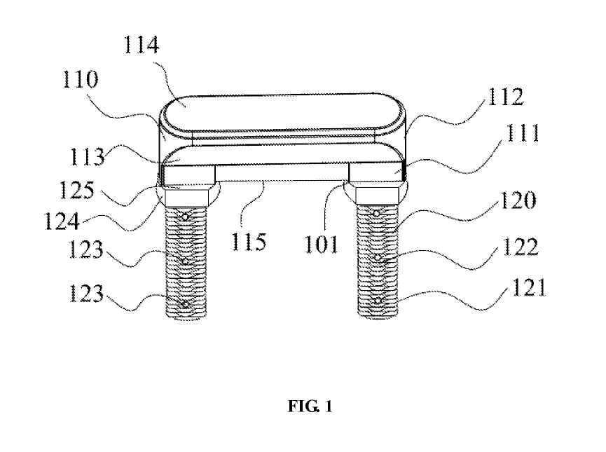

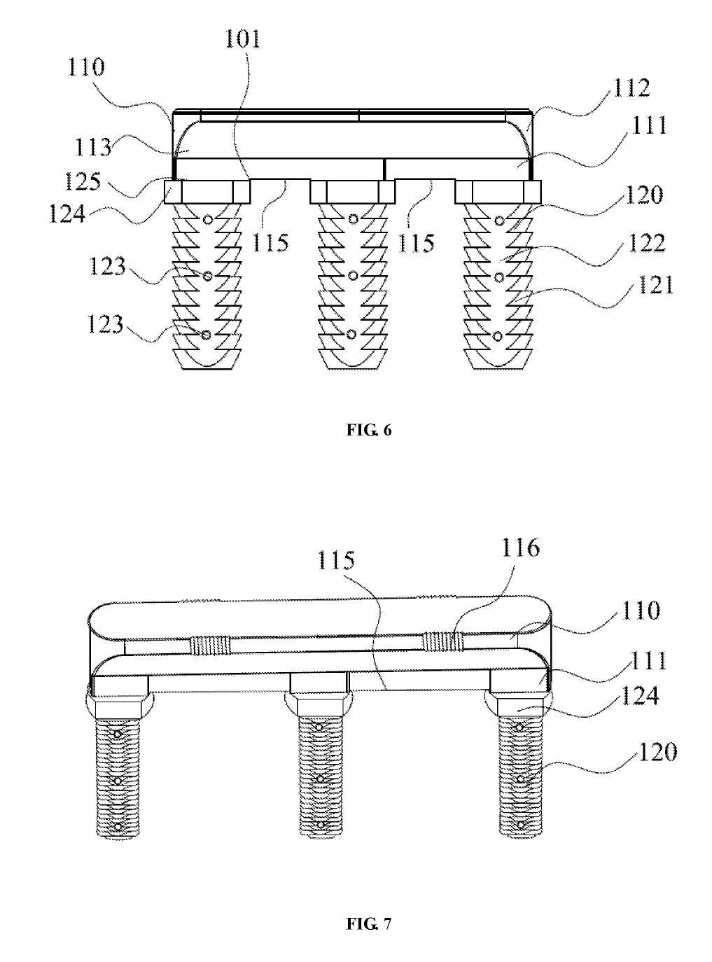

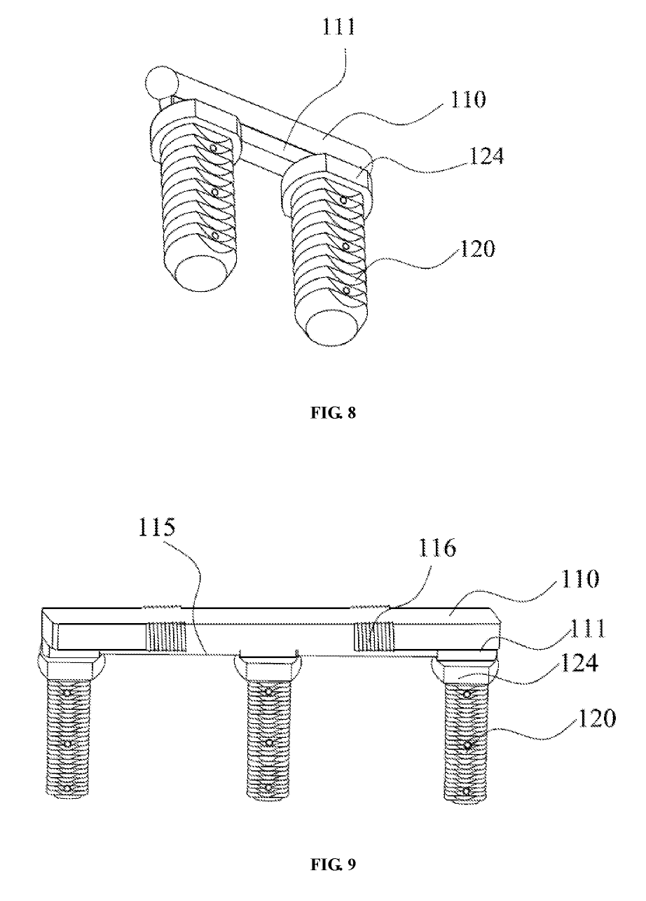

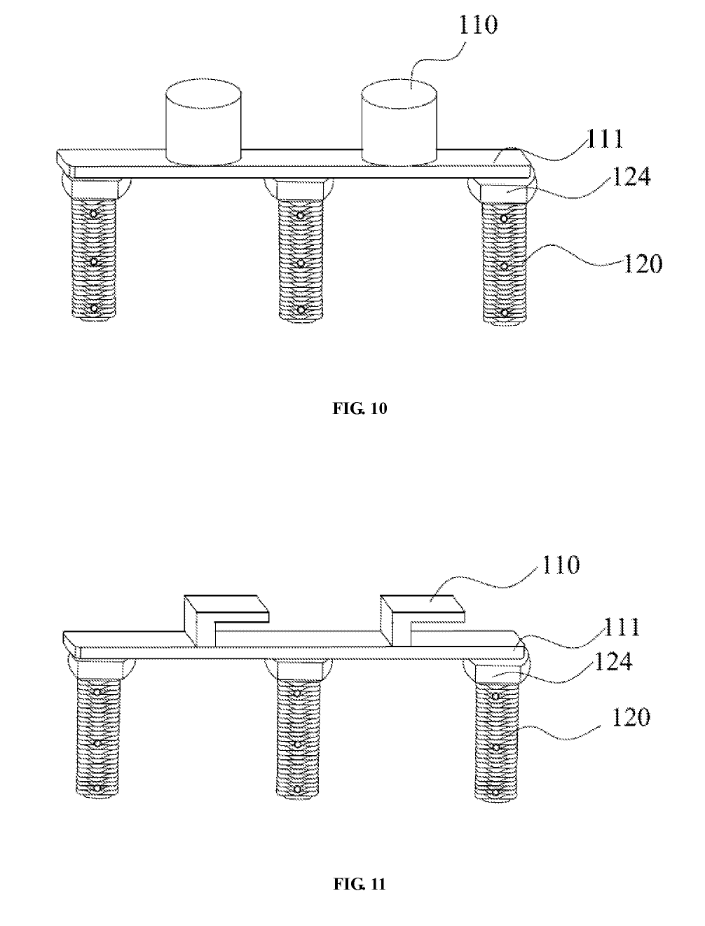

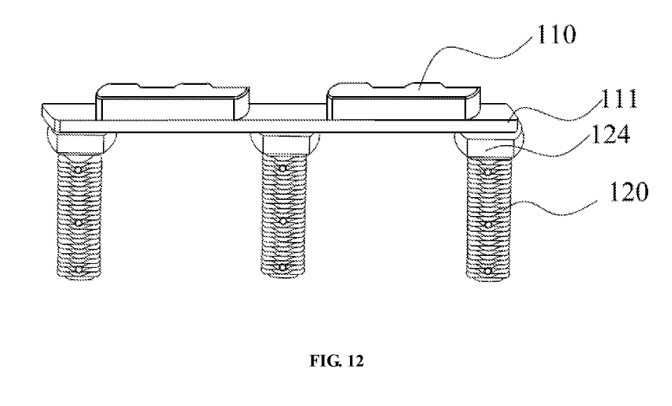

First, referring to FIG. 1, FIG. 6, FIG. 7, FIG. 8, FIG. 9, FIG. 10, FIG. 11 and FIG. 12, a furniture connecting piece 100, includes a base 111, at least one tenon 110 is arranged on the base 111, and at least two columns 120 arranged at the bottom of the base 111. In FIG. 1 and FIG. 5, the tenon 110 is designed as elliptic cylinder with big top and small bottom, the upper 112 of the tenon 110 is elliptic cylindrical, the lower part 113 of the tenon 110 is removed apart from both sides of the elliptic cylinder to form triangular cross section. However, it should be understood that the shape of the tenon 110 is not limited in the invention. For example, FIG. 7, FIG. 8, FIG. 9, FIG. 10, FIG. 11 and FIG. 12 show other shapes of the tenon 110, which will be described in details in below.

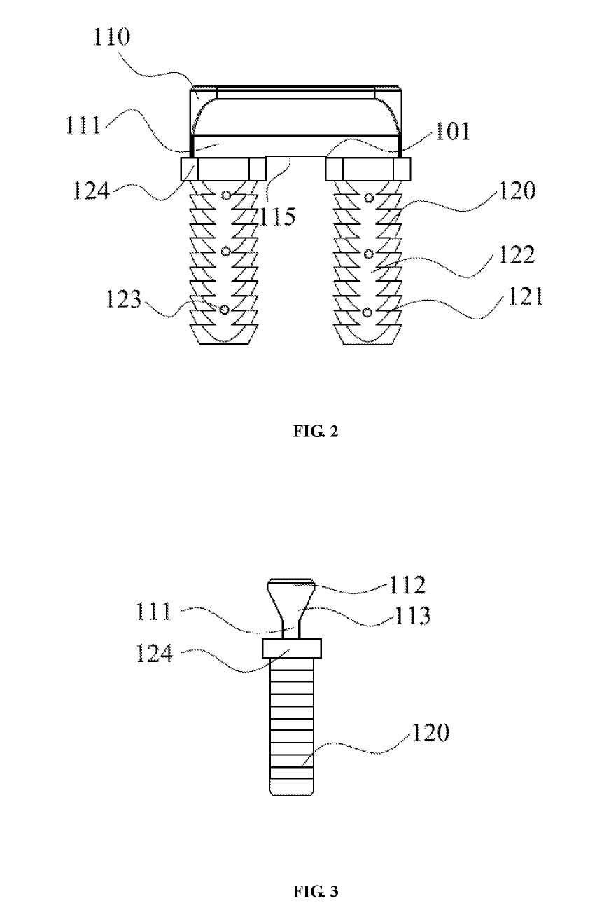

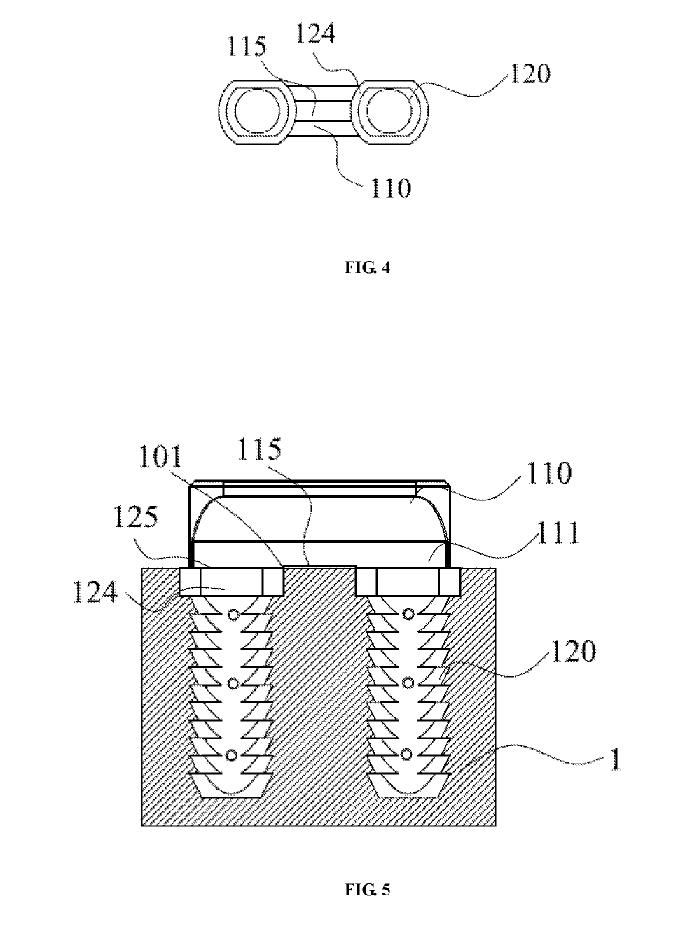

Preferably, referring to FIG. 1, FIG. 2, FIG. 3 and FIG. 4, the column 120 is provided with chamfered teeth 121 around its body. With the chamfered teeth the furniture connecting piece 100 can firmly bite the wall of furniture plate. When the furniture connecting piece 100 is inserted into the mounting hole in the furniture plate, the column 120 will extrude the wall of the mounting hole, the furniture plate will suffer pressure. If the furniture plate is thinner or the expanding properties of the furniture plate are worse, it is easy to burst or damage. Preferably, the front and rear sides 122 of the column along its length direction are set as plane, thus the area of the chamfered teeth 121 will be reduced, the pressure on the furniture plate will be reduced, thereby avoiding the furniture plate to burst or damage.

Preferably, referring to FIG. 1, FIG. 2, some glue holes 123 are arranged on the plane 122 on the column 120 for holding some glue to provide firmly connection.

Preferably, referring to FIG. 1 and FIG. 6, the number of the column 120 in the furniture connecting piece 100 is at least two. It can be set as will. However, the space between two adjacent two columns is equal.

Preferably, referring to FIG. 1, FIG. 2, FIG. 3 and FIG. 4, a terrace 124 is arranged between the base 111 and the column 120. The diameter of the terrace 124 is bigger than the that of the column 120. Generally, before the column 120 is inserted into the mounting hole in the furniture plate, some glue will be filled in the mounting hole and coated around the column. It depends on the frictional force between the column and the wall of the mounting hole and the adhesive force of the glue to fix the furniture connecting piece 100 and the furniture plate. When the column 120 is inserted into the mounting hole, the glue will spill over the mounting hole. The terrace 124 can block the mounting hole and prevent the spillover of the glue, therefore increasing connection strength. And that, the diameter of the terrace 124 is bigger, also increases the connection area between the column 120 and the tenon 110 therefor increasing the connection strength of them.

Preferably, the top surface 125 of the terrace 124 is a plane. Referring to FIG. 5, When the furniture connecting piece 100 is inserted into the mounting hole in the furniture plate 1, the top surface 125 of the terrace 124 can be set at the same level with the furniture plate 1, while the bottom face 115 of the tenon 110 between two of the terrace 124 must be on the furniture plate 1. Therefore, the bottom face 115 of the tenon 110 between two of the terrace 124 can not be at the same level with the top surface 125 of the terrace 124. There must be a little spacing 101 between them, The bottom face 115 of the tenon 110 between two of the terrace 124 is higher than the top surface 125 of the terrace 124. Thus, when the tenon 110 of the furniture connecting piece 100 is held in the mortise of the other furniture plate, both of the furniture plates can be connected seamlessly.

Preferably, referring to FIG. 7, both side faces 116 of the upper 112 of the tenon 110 is arranged some chamfered teeth.

Referring to FIG. 8, FIG. 9, FIG. 10, FIG. 11 and FIG. 12 show other shape of the tenon 110, the tenon 110 in FIG. 8 is cylinder shape, the tenon 110 in FIG. 9 is cuboid shape, the tenon 110 in FIG. 10 are two cylinders, the tenon 110 in FIG. 11 are two “L” shape, the tenon 110 in FIG. 12 are two blocks. The present invention is not limited the shape and the size of tenon 110. In fact, the shape and the size of the tenon 110 can be changed at will without divorcing from the basic idea of the invention.

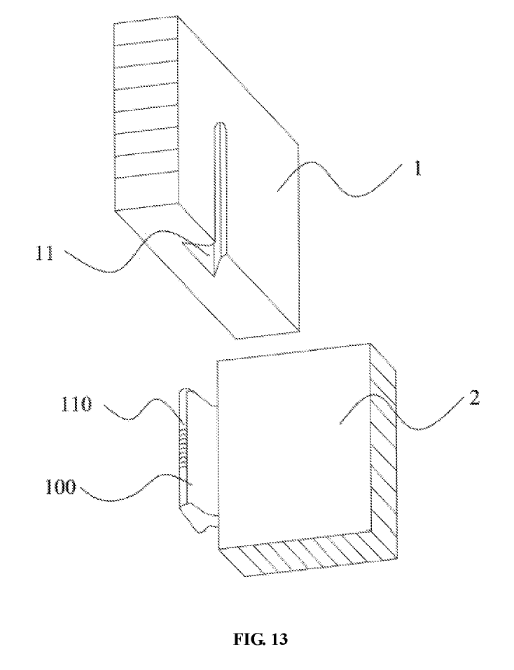

Referring to FIG. 13, The furniture connecting piece 100 is used to connect two plates. The first plate 1 is provided with a mounting hole 11, the furniture connecting piece 100 is fixedly installed in the second plate 2 with the column 120 inserting into it. The mounting hole 11 and the tenon 110 are matched with each other in shape and size. The tenon 110 is inserted into the mounting hole 11, the chamfered teeth at both side faces 116 of the upper 112 of the tenon 110 tightly bites the wall of the mounting hole 11, thereby connecting the two plates.

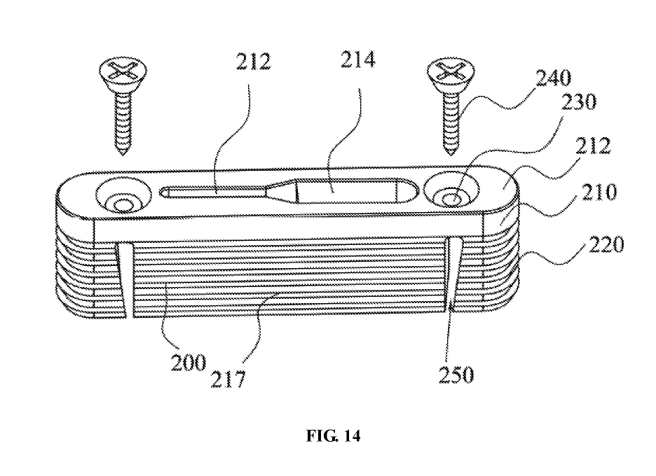

Referring to FIG. 14, The furniture connecting piece 100 can be used with the other furniture connecting piece 200 in pairs. The furniture connecting piece 200 has been disclosed in U.S. Pat. No. 8,641,315, B2. The furniture connecting piece 200 includes a base 210 and screws 240. The base 210 has opposite upper surface 212 and lower surface, opposite left and right surface 220, and opposite front surface 217 and back surface (not show). The lower surface 211 of the base has gaped grooves 250 extending to the upper surface 212 of the base. The gaped groove 250 runs through the front surface 217 and the back surface of the base 210. The upper surface 212 of the base is provided with screw holes 230 communicating with the gaped grooves 250, the screw 240 passes through the screw hole 230 and is partially contained within the gaped groove 250. The upper surface 221 of the base 210 defines one or some recesses 214 extending to the lower surface of the base. The mortise 214 can hold the tenon 110, thereby joining the furniture connecting piece 100 and the furniture connecting piece 200.

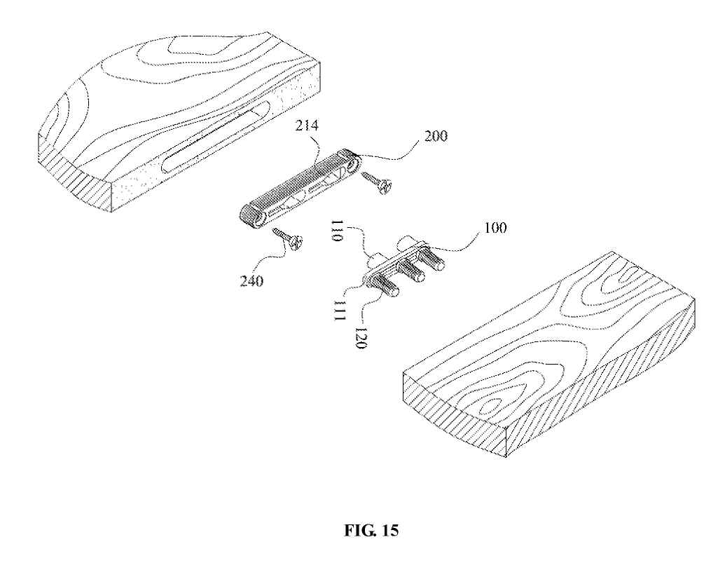

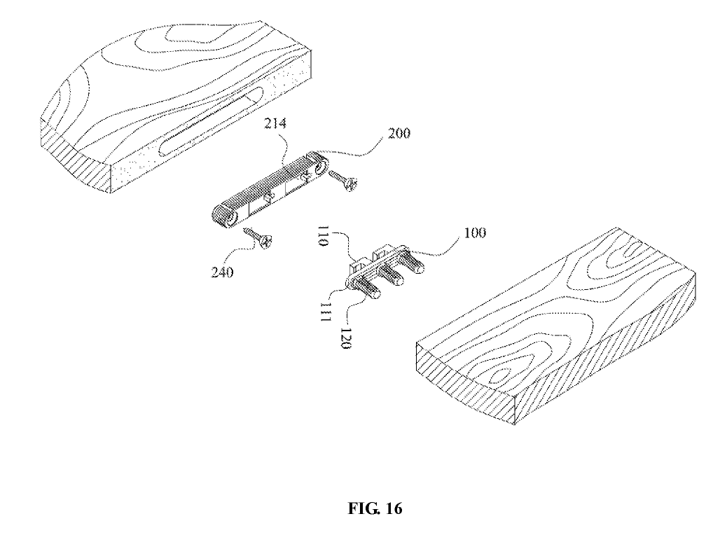

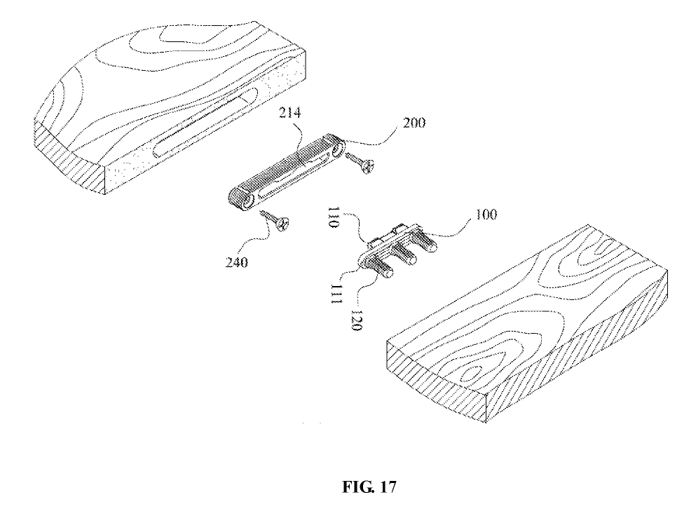

Referring to FIG. 15, FIG. 15 is a view of embodiment of the pair of furniture connecting pieces in the invention. A pair of furniture connecting pieces comprises of the furniture connecting piece 100 and the female furniture connecting piece 200, the furniture connecting piece 100 includes a base 111, at least one tenon 110 is arranged on the top of the base 111, and at least two columns 120 are arranged at the bottom of the base 111. The furniture connecting piece 200 has a base 210, at least one mortise 214 is arranged on the top of the base 210 extending to the lower surface of the base, the mortise 214 can interlock joint with the tenon 110. The mortise 214 includes a leading mortise connecting with a capacity mortise. When the furniture connecting piece 100 is used in conjunction with the female furniture connecting piece 200, the tenon 110 is inserted into the leading mortise of the mortise 214, then slides in the mortise 214 and enters the capacity mortise and is matched with the mortise 214 tightly, thus the furniture connecting piece 100 and the furniture connecting piece 200 are engaged with each other. In the present invention, when the furniture connecting piece 100 is matched with the furniture connecting piece 200, the number of the tenon 110 is equal to the number of the mortise 214, and the shape of both can fit each other. FIG. 15, FIG. 16 and FIG. 17 respectively show a few different shapes of the tenon 110 of the furniture connecting piece 100 and the mortise 214 of the female furniture connecting piece 200 that can be complement each other. And, in FIG. 15, the tenon 110 a cylinder with elliptical cross section, the mortise 214 comprises of a leading mortise with elliptical cavity and the capacity mortise which can be tightly complement with the tenon 110; In FIG. 16, the tenon 110 is L-shape, the mortise 214 comprises of a leading mortise with L-shaped cavity and the capacity mortise which can be tightly complement with the tenon 110; In FIG. 17, the tenon 110 is two tandem cylinders with elliptical cross section, the mortise 214 comprises of a two tandem leading mortise with elliptical cavity and the capacity mortise which can be tightly complement with the tenon 110.

Of course, it should be known that FIG. 15, FIG. 16 and FIG. 17 only show a few examples of the shapes of the tenon 110 and the mortise 214, those are not to limit the shapes of the tenon 110 of the furniture connecting piece 100 and the mortise 214 of the furniture connecting piece 200 in the present invention.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A furniture connecting piece, comprising:
a base, comprising at least one tenon and at least two columns;
wherein said tenon is arranged on the top of said base; and
said columns are arranged at the bottom of said tenon.

2. The furniture connecting piece according to claim 1, wherein said column is provided with chamfered teeth around its body.

3. The furniture connecting piece according to claim 2, wherein a front side and a rear side of said column along its length direction are disposed as planes.

4. The furniture connecting piece according to claim 3, wherein a plurality of glue holes are arranged on said planes on the column.

5. The furniture connecting piece according to claim 1, wherein a terrace is arranged between said base and said column.

6. The furniture connecting piece according to claim 5, wherein the diameter of said terrace is bigger than that of said column.

7. The furniture connecting piece according to claim 6, wherein a top surface of said terrace is a plane, the bottom face of said tenon between two of said terrace is higher than said top surface of said terrace.

8. The furniture connecting piece according to claim 1, wherein said tenon is provided with some sawteeth.

9. The furniture connecting piece according to claim 1, wherein said tenon is designed as elliptic cylinder with big top and small bottom, the upper portion of said tenon is elliptic cylindrical, a lower part of said tenon is removed apart from both sides of said elliptic cylinder to form a triangular cross section.

10. A pair of furniture connecting pieces, comprising: a furniture connecting piece and a female furniture connecting piece;
wherein said furniture connecting piece includes a base, at least one tenon is arranged on top of said base, at least two columns are arranged at bottom of said tenon;
said female furniture piece includes a base with a mortise matching with said tenon and used for holding and locking said tenon.
